(19) United States
(12) Patent Application Publication
(10) Pub. No.: US 2007/0281880 A1
(43) Pub. Date: Dec. 6, 2007

(54) Multiple use fabric conditioning composition comprising hydrophobic perfume ingredients

(76) Inventors: George Kavin Morgan, Hamilton, OH (US); Zaiyou Liu, West Ghester, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/447,388

(22) Filed: Jun. 6, 2006

(51) Int. Cl. C11D 3/00

(52) U.S. Cl. 510/515

(57) ABSTRACT

Multiple use fabric conditioning compositions comprising hydrophobic, free perfume ingredients are useful for conditioning fabric in an automatic clothing dryer.

### FIELD OF THE INVENTION

The invention relates to an improved fabric conditioning composition and the methods using and manufacturing the same.

### BACKGROUND OF THE INVENTION

Dryer-added fabric conditioning products provide a better convenience to the consumer as compared to the rinse-added fabric conditioning products because they spare the consumer the requirement of having to be present right at the beginning of the rinse cycle. Multiple-use, dryer-added products provide greater convenience to the consumer than a single use product because the consumer need not remember to place the product in the dryer with every dyer cycle. See e.g., U.S. Pat. Nos. 3,634,947; 3,676,199; 3,967,008; 4,004,685; 4,014,105; 4,014,432; 4,053,992; 4,149,977; 4,642,908; 5,040,311; 5,300,238; 5,480,567; 5,787,606; 5,966,831; 6,908,041; 6,908,040; and U.S. Pat. Pub. Nos.: 2003/0192197; 2003/0195130; 2005/0192204; 2005/0192207. However, many multiple-use products may not provide consistent fabric conditioning benefits and perfume delivery over the course of the product's entire life cycle, particularly those products designed for twenty or thirty or more dryer cycles. One reason for the decrease or inconsistent performance for these multiple-use products may be attributed to the repeated heating and cooling dryer cycles annealing and thereby hardening the product leading to poor, end of life, performance.

Thus, there is a continuing need to provide a multiple use fabric conditioning product that provides more consistent levels of fabric conditioning actives and perfume deposition on to fabric throughout the life-cycle of the product.

Another problem with making the multiple use fabric conditioner composition is the concentration gradients of perfume compositions across the radial thickness of the composition. This is caused by the preferential crystallization of the ingredients in the composition when solidifying the hot, melt compositions. This process also may cause the perfumes to form gradient along with the conditioning composition. This undesirable composition gradient may cause differences in the rate of release of both conditioner actives and perfume thereby preventing the user from experiencing a consistent performance through the life cycle of the product. Thus, there is a need to reduce such concentration gradients across components in the fabric conditioner composition.

### SUMMARY OF THE INVENTION

The present invention attempts to address this and other needs. Accordingly, a first aspect of the invention provides a multiple-use, fabric conditioning composition comprising:
(a) a fabric conditioning active;
(b) a carrier component; and
(c) a free perfume composition comprising free perfume ingredients, wherein at least about 50% of the free perfume ingredients, by total weight of said free perfume composition, have an octanol/water partitioning coefficient (“Clog P”) equal to or higher than about 3;
   wherein the composition is operably connectable to an inside surface of an automatic clothes dryer.

In one embodiment, the free perfume composition is further characterized in that at least about 25% of the free perfume ingredients, by total weight of said free perfume composition, having a boiling point equal to or higher than about 240° C.

In an alternative embodiment, the free perfume composition is further characterized in that at least 25% of the free perfume ingredients, by total weight of said free perfume composition, have a boiling point equal or higher than about 250° C.

Another aspect of the present invention provides for a method of conditioning a fabric comprising the step of contacting said fabric with a composition of the present invention, preferably contacting the fabric inside an automatic clothes dryer.

The multiple use fabric conditioning composition of the present invention is preferably operably connected to a composition carrier to form a multiple use fabric conditioning article. In turn, the fabric conditioning article is preferably operably connectable to an inside surface of a clothes dryer. In a preferred embodiment, the article further comprises a docking member, wherein the composition carrier is operably connectable to the docking member, and in turn, the docking member is operably connectable to the inside surface of a clothes dryer. In an alternative embodiment, the fabric conditioning article is free or substantially free of a composition carrier or a docking member.

### BRIEF DESCRIPTION OF THE DRAWINGS

FIG. 1. The graph of FIG. 1 illustrates the release of the three fabric conditioning compositions, each comprising a different free perfume composition, after each drying cycle over the course of ten dryer cycles.

### DETAILED DESCRIPTION OF THE INVENTION

A “free perfume composition” is a composition of one or more free perfume ingredients. In turn, the term “free perfume ingredient” means, for purposes of the present invention, a compound that imparts a desirable odor to treated fabric as understand by one skilled in the art in the perfume arts that is neither absorbed onto or into a perfume carrier (e.g., absorbed on to zeolites or clays or cyclodextrins) nor encapsulated (e.g., in a perfume microcapsule).

A “pro-perfume” is included within the present definition of a “perfume ingredient.” The term “pro-perfume” is generally described at US 2005/0192204 A1, ¶5 et seq., and the references cited therein. An example of a pro-perfume is a Cliff-base, see e.g., U.S. Pat. Publ. Nos. 2005/0239667 A1; 2005/0043208 A1; 2004/0106528 A1; 2003/0153474 A1; 2003/0064899 A1.

In the perfume arts, it is appreciated that some materials having no odor or very faint odor are used as diluents or extenders. Non-limiting examples of these materials are dipropylene glycol, diethyl phthalate, triethyl citrate, isopropyl myristate, and benzyl benzoate. These materials are used for, e.g., diluting and stabilizing some perfume ingredients. For purposes of this invention, these materials are neither included within the definition of “perfume ingredient” nor “free perfume ingredient,” and thus are specifically excluded as part of the term “free perfume composition.”

One suitable way to measure and identify free perfume ingredients includes the use of a Gas Chromatography/Mass Spectrometer system (GC/MS). For example, a 2-gram sample of the multiple use fabric conditioning composition is extracted with 5-mL dichloromethane (HPLC grade, Sigma-St. Louis Mo.). The extract is passed through a cation extraction resin to remove cationic surfactants. The supernatant is concentrated under gentle nitrogen to less than 1.0-mL, and reconstituted with dichloromethane to 1.0-ml. The concentrated extracts containing the free perfume composition is then analyzed using Agigent 5973 or 5972 GC/MS system. Free perfume ingredients are identified using perfume Mass Spectrometry library developed from the National Bureau of Standard and Technologies (NIST), 2002 Edition. The quantitation of the free perfume ingredients are accomplished using Flame ionization detector or selected ion monitoring methods (sycg as mass spectrometry) or combinations thereof, depending upon on resolution and level of interferences.

Not wishing to be bound to any theory, it is believed that the free perfume composition that is incorporated into a multiple-use fabric conditioning composition which goes through many heating and/or softening cycle can be depleted by diffusion and/or volatility. Furthermore, it is believed that during the life span of the composition, the more volatile free perfume ingredients diffuse faster and are depleted faster from the fabric conditioning composition. Therefore, not only the strength of the perfume impacted on the garments is lower at later drying cycles due to the perfume loss, but also the perfume character also changes in later cycles due to a disproportionately higher loss of the high volatile free perfume ingredients. It is further believed that the free perfume composition that is intimately blended in the solid fabric conditioning composition has the effect of softening that solid conditioning composition thereby increasing the dispensing rate of the fabric conditioning active to the fabric. In earlier drying cycles, the solid composition contains proportionally more perfume thus is softer and releases more active to the fabric per cycle as compared to later cycles when the solid fabric conditioning composition contains proportionally less perfume (due to perfume loss); thus, the solid fabric conditioning composition becomes harder and releases less active to the fabric per cycle (particularly in later cycles of the life span of the composition).

It is yet further believed, without wishing to be bound by theory, that free perfume composition may serve as a solvent in the crystal formation during extrusion and stamping process for the solid fabric conditioning composition. In this context, free perfume compositions containing different perfume ingredients show a different solvent property, thus resulting in varying levels of effects on the hardness of the solid fabric conditioning composition, and thus affecting the rate of release of fabric conditioning active and perfumes. For a given multiple use fabric conditioning composition, it is observed that free perfume compositions containing high levels of hydrophobic perfume ingredients lead to harder conditioning compositions than that of free perfume compositions containing lower levels of the hydrophobic free perfume ingredients. The present invention is based, in part, on this observation. It is observed that hydrophobic free perfume ingredients having an octanol/water partitioning coefficient (hereinafter “Clog P”) equal to or greater than about 3.0, preferably equal to or greater than about 3.5, provide for more a consistent delivery of fabric conditioning active and/or perfume deposition to fabric throughout the life span of the product, with specific mention to the later end of the product life cycle (e.g., 30^{th}, 40^{th}, 50^{th}, or more cycle).

Three examples of multiple use fabric conditioning composition each comprising a different free perfume ingredient, are provided to illustrate the impact that perfume has on the release profile of the fabric conditioning composition when the composition is employed to soften damp laundry in an automatic clothing dryer. The only variable between the three compositions is the ingredients that comprise the free perfume composition. To this end, the free perfume ingredients vary in the degree of the weight percentage that contain a ClogP value greater than or equal to 3.0. The three free perfume compositions are as follows:

| | Example A | Example B | Example C |
|---|---|---|---|
| Ingredients | Wt. % | Wt. % | Wt. % |
| Acrawax C^{(a)} | 57.0 | 57.0 | 57.0 |
| KRA^{(b)} | 41.0 | 41.0 | 41.0 |
| Perfume A | 2.0 | — | — |
| Perfume B | — | 2.0 | — |
| Perfume C | — | — | 2.0 |
| Total | 100 | 100 | 100 |

^{(a)}Ethylene bis-stearamide is available from Lonza.
^{(b)}Di-(tallowoyloxyethyl)-N,N-methylhydroxyethylammonium methyl sulfate is available from Degussa.

The multiple use fabric conditioning composition, not including any composition carrier or docking member (e.g., “product dispenser” and/or “carrier” per U.S. Pat. Publ. No. 2003/0192197 A1), weighs about 55 grams.

Perfume A, B, and C are free perfume compositions of different free perfume ingredients. Perfume A contains 36.8%, by weight of the free perfume composition, of free perfume ingredients with a ClogP value of 3.0 or greater. Perfume B contains 77.2%, by weight of the free perfume composition, of free perfume ingredients with a ClogP value of 3.0 or greater. Perfume C contains 100%, by weight of the free perfume composition, of free perfume ingredients with a ClogP value of 3.0 or greater.

The release data is generated using damp laundry in an automatic laundry dryer. The damp laundry consists of a 7.5 lb fabric bundle (dry weight) containing a mixture of fabric types such as cotton, polyester, & blends thereof. In a U.S.A. top loading automatic laundry washing machine, each bundle is washed with 17 gallons of 90° F. water for a 12 minute cycle using a perfume-free detergent matrix. Each bundle is then rinsed with 60° F. water. After rinsing, free and/or vicinal water is removed from bundle by being subjected to a spin cycle. Each washed fabric bundle is placed in an automatic laundry dryer where the multiple use fabric conditioning article is attached to the fin of the barrel of the dryer. Each fabric bundle is dried for 55 minutes with a 10 minute cool down cycle. Each multiple use fabric conditioning composition is removed after each cycle and weighed to determine the amount of the fabric conditioning composition that was released during the cycle.

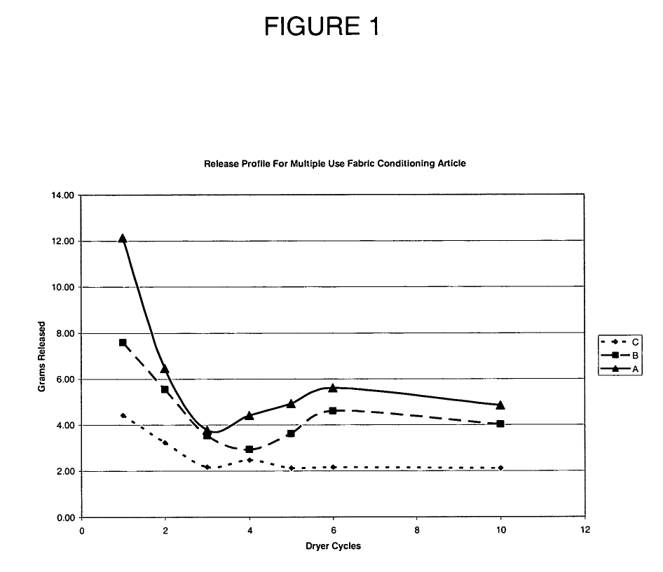

The graph of FIG. 1 illustrates the release of the three respective fabric conditioning compositions after each drying cycle over the course of ten dryer cycles. The Y axis defines the amount of the composition that is released while the X axis defines the number of dryer cycle. As the graph illustrates, Perfume A, which is outside the scope of the present invention, has a dramatic decrease in the amount of the composition that is released between the first dryer cycle and the third dryer cycle. The first cycle of fabric conditioning composition deposited about 12 grams, whereas the third cycle released less than about 4 grams of the composition. This represents nearly a three-fold difference of the composition that is released. In contrast, Perfume C, a preferred embodiment of the present invention, released a little over 4 grams of the fabric conditioning composition and about 2 grams of the composition at the third dryer cycle. This represent only about a two-fold difference between the amount of the fabric conditioning composition released from the first to the third dryer cycle. Not only does the data demonstrate that the free perfume composition of the present invention provides a more consistent release of fabric conditioning composition during the initial dryer cycles but likely the occurrence of fabric staining that may occur when such high levels of the composition are released in the initial dryer cycle (as in Perfume A).

In one embodiment of the invention, the composition exhibits a release profile, on a weight-by-weight basis, comparing the first cycle with that of the third cycle, of less than about 3:1, respectively. In another embodiment, this ratio is less than about 3:2, preferably less than 5:3, more preferably less than 2:1, respectively. In yet another embodiment, this ratio is about 1:1, respectively. In yet still another embodiment, these ratios are over 5 cycles, preferably 10 cycles, more preferably 20 cycles, still more preferably 30 cycles.

A first aspect of the present invention provides a multiple-use, fabric conditioning composition comprising a free perfume composition, wherein the free perfume composition comprises free perfume ingredients, wherein the free perfume ingredients comprise an octanol/water partitioning coefficient (“Clog P”) equal to or higher than about 3.

There are many suitable ways of measuring or calculating ClogP for purposes of the present invention. For purposes of the present invention, the term “ClogP” includes reported logP values, experimental logP values, or calculated logP values. For example, the logP of many perfume ingredients has been reported; for example, the Promona92 database, available from Daylight Chemical Information Systems, Inc. (Daylight CIS), Irvine, Calif., contains many, along with citations from the original literature. However, the logP values are mostly conveniently calculated by the “CLOGP” program, also available from Daylight CIS. This program also lists experimental logP values when they are available in the Promona92 database. The calculated logP is determined by the fragment approach on Hansch and Leo (cf., A. Leo, in comprehensive medicinal chemistry, Vol. 4, C. Hansch, P. G. Sammens, J. B. Taylor and C. A. Ransden, Eds., P. 295, Pergamon Press, 1990, incorporated herein by reference). The Fragment approach is based on the chemical structure of each perfume ingredient, takes into account the numbers and types of atoms, the atom connectivity, and chemical bonding. The calculated logP values, which are the mostly reliable and widely used estimates for this physicochemical property, are preferably used instead of the experimental logP values in the selection of free perfume ingredients which are useful in the present invention.

In a preferred embodiment, the free perfume composition contains at least about 50%, or at least about 60%, or at least about 70%, or at least about 80%, or at least about 85%, or at least about 90%, or at least about 95%, or at least about 97%, alternatively not greater than about 99%, free perfume ingredients by weight of free perfume composition in the multiple use fabric conditioning composition; wherein the free perfume ingredients have a Clog P equal to or higher than about 3.0, preferably equal to or higher than about 3.2, preferably equal to or higher than about 3.4, preferably equal to or higher than about 3.5, preferably equal to or higher than about 3.6.

Non-limiting examples of hydrophobic free perfume ingredients that may be useful in the compositions of the present invention include hexyl 2-methylbutanoate, dimethyl benzyl carbinyl butyrate, diphenylmethane, diphenyloxide, alpha-hexylcinnamaldehyde, p-toyl phenylacetate, isobutyl phenylacetate, phenethyl phenylacetate, geranyl phenylacetate, dimethyl phenylethyl carbinyl acetate, benzyl butyrate, benzyl cinnamate, beta-bromstyrol, cyclamen aldehyde, ethyl linalool, anethole, gamma undecalactone, isobutyl caproate, citronellyl formate, geranyl formate, geranyl acetate, ethylene brassylate, pentadecanolide, 3,7-dimethyl-1-octanol, citronellol, citronellal, geranyl butyrate, ethyl heptoate, methyl n-nonyl acetaldehyde, methyl 2-nonynoate, myrcenyl acetate, methyl nonyl ketone, capric alcohol, capraldehyde, undecanal, 10-undecanal, lauraldehyde, dihydrojasmone, linalyl acetate, linalyl formate, vetivert acetate, benzyl salicylate, benzophenone, isoeugenol benzyl ether, benzyl benzoate, alpha-amylcinnamaldehyde, benzyl isoamyl ether, beta-myrcene, 8-hexadecenolide, nonaldehyde, isobornyl acetate, 2-(sec butyl)-1-vinylcyclohexyl acetate, methyl 2-hexyl-3-oxo-cyclopentanecarboxylate, 5-cyclohexadecenone, isohexenyl cyclohexenyl carboxaldehyde, 2-decenal, isononyl acetate, 14-oxabicyclo[10.3.0]-2-pentadecene, 2-isopropyl-5-methylhexyl acetate, linalool ethyl acetal, cis-3-hexenyl isobutyrate, trans-anethole, 3,4,5,6-tetrahydropseudoionone, farnesol, 2-dodecenal, bisabolene, p-menthan-8-ol, carvacrol, cyclopentadecanone, geranyl nitrile, citronellyl nitrile, 2,4,6-trimethyl-4-phenyl-1,3-dioxane, dihydromyrcenol acetate, n-pentyl butyrate, muscone, hexyl neopentanoate, dibutyl sulfide, decyl propionate, 2-butyl-4,4,6-trimethyl-1,3-dioxane, cyclic ethylene dodecanedioate, 3-methyl-5-phenyl-1-pentanol, phenethyl isoamyl ether, camphene, isopulegyl acetate, cis-8-undecen-1-al, 3,5,5-trimethylhexyl acetate, formaldehyde cyclododecyl ethyl acetal, terpinolene, dihydro-alpha-terpinyl acetate, tetrahydrogeranial, alpha-amyl-cinnamaldehyde diethyl acetal, 3,7-dimethyl-2(3),6-nonadienenitriles, vetiveryl acetate, n-hexyl salicylate, 1-(4-isopropylcyclohexyl) ethanol, trans-4-decen-1-al, and combinations thereof.

In one embodiment, the free perfume composition of the present inventions comprises at least about 2 different, or at least about 3, or at least about 4, or at least about 5, or at least about 6, or at least about 7, or at least about 8, or at least about 9, or at least about 10, different free perfume ingredients that all have a ClogP equal to or higher than about 3, preferably equal to or higher than about 3.5.

In one embodiment, the multiple use fabric conditioning composition of the present invention comprises from about 0.01% to about 15%, alternatively from about 0.05% to about 10%, alternatively from about 0.1% to about 6%; alternatively about 0.3% to about 4%, or alternatively from about 0.5% to about 3%, of a free perfume composition, by weight of the multiple use, fabric conditioning composition.

The following are non-limiting examples of high hydrophobic free perfume ingredients of the present invention:

Example Perfume Composition A–C

| | | Example | Example | |
|---|---|---|---|---|
| | CLogP | A | B | Example C |
| Ingredients | Value | Wt. % | Wt. % | Wt. % |
| 2 Decene-1-al | 3.694 | 1 | 2 | 1 |
| Amyl Proprionate | 2.697 | 2 | 1 | |
| Methyl Nonyl | 4.846 | 2 | 3 | 2 |
| Acetaldehyde | | | | |
| Benzyl Butyrate | 3.018 | 2 | 3 | 2 |
| Ligustral | 2.531 | 25 | 12 | |
| Anethol USP | 3.314 | 5 | 7 | 5 |
| Citronellyl Acetate | 4.199 | 10 | 15 | 15 |
| Dihydro Myrcenol | 3.033 | 20 | 25 | 35 |
| Linalool | 2.549 | 18 | 10 | |
| Undecalactone | 3.830 | 7 | 15 | 25 |
| Para Cresyl Methyl Ether | 2.560 | 5 | 2 | |
| Verdox | 4.059 | 3 | 5 | 15 |
| Total | | 100 | 100 | 100 |

Low hydrophobicity free perfume ingredients, which are preferably minimized in multiple use conditioning compositions of the present invention, are those having a Clog P of less than about 3. In some embodiments of the fabric conditioning compositions, some low hydrophobicity free perfume ingredients can be used in small amounts, e.g., to balance product odor characters.

### Low Volatile Perfume Ingredients

Another aspect of the invention provides for a free perfume ingredient that is characterized in having a Clog P equal to or higher than about 3, and having a boiling point equal to or higher than about 240° C.

The boiling point of many perfume ingredients are given in, e.g., “Perfume and Flavor Chemicals (Aroma Chemicals),” S. Arctander, published by the author, 1969. Other boiling point values can be obtained from different chemistry handbooks and databases, such as the Beilstein Handbook, Lange's Handbook of Chemistry, and the CRC Handbook of Chemistry and Physics. When a boiling point is given or measured at a non-standard pressure, usually at a pressure lower than the standard pressure, the boiling point at standard pressure can be approximately estimated by using boiling point-pressure nomographs, such as those given in “The Chemist's Companion,” A. J. Gordon and R. A. Ford, John Wiley & Sons Publishers, 1972, pp. 30-36. When applicable, the boiling point values can also be calculated by computer programs, based on molecular structural data, such as those described in “Computer-Assisted Prediction of Normal Boiling Points of Pyrans and Pyrroles,” D. T. Stanton et al, J. Chem. Inf. Comput. Sci., 32 (1992), pp. 306-316, “Computer-Assisted Prediction of Normal Boiling Points of Furans, Tetrahydro-furans, and Thiophenes,” D. T. Stanton et al, J. Chem. Inf. Comput. Sci., 31 (1992), pp. 301-310, and references cited therein, and “Predicting Physical Properties from Molecular Structure,” R. Murugan et al, Chemtech, June 1994, pp. 17-23.

In one embodiment, the free perfume ingredients are characterized by having at least about 50%, or about 60%, or about 70%, or about 80%, or about 90%, or about 100%, by the total weight of free perfume composition, have a Clog P equal to or higher than about 3.0, preferably equal to or higher than about 3.5; wherein the free perfume ingredients are further characterized in that at least about 25%, or about 35%, or about 45%, or about 55%, or about 65%, or about 75%, alternatively not greater than about 99%, by total weight of free perfume composition, comprise a boiling point equal to or higher than about 240° C., more preferably equal to or higher than about 250° C., wherein the boiling point is measured at standard pressure (i.e., 760 mm Hg).

In yet another embodiment, the free perfume ingredients of the present invention may contain at least about 3, or 4, or 5, or 6, or 7, or 8, or 9 or 10, or more, different free perfume ingredients each having a boiling point equal to or higher than about 240° C., more preferably equal to or higher than about 250° C.; wherein each free perfume ingredient also have a Clog P equal to or higher than about 3, preferably equal to or higher than about 3.5.

These “low volatile” free perfume ingredients may help to reduce the variation in the rate of release of fabric conditioning active and/or reduce the variation in the strength and the character of the delivered perfume during the life span of the composition, and/or reduce the odor of the composition, especially the initial odor of the composition; and may also provide more a consistent delivery of conditioning active and/or perfume deposition to fabric throughout the life span of the product.

### Perfume Delivery Systems

Another aspect of the invention provides for a multiple use fabric conditioning composition further comprising a perfume delivery system. The term “perfume delivery system” does not include a free perfume ingredient. Non-limiting examples of perfume delivery systems include perfume microcapsules, cyclodextrin, cellular matrix microcapsules, and porous carrier microcapsules. In one embodiment, the multiple use fabric conditioning composition comprises from about 0.001% to about 15%, by weight of the multiple use fabric conditioning composition, of a perfume delivery system.

Perfume Microcapsule. In one embodiment, the perfume delivery system comprises a perfume microcapsule. In turn, a perfume microcapsules comprising an encapsulated perfume. The “encapsulated perfume” is not, for purposes of the present invention, within the definition of the term “free perfume composition.” A perfume microcapsule provides a latent source of perfume and is generally described in US 2005/0192204 A1, 37-43. Perfume microcapsules are also described in US 2003/215417 A1; US 2003/216488 A1; US 2003/158344 A1; US 2003/165692 A1; US 2004/071742 A1; US 2004/071746 A1; US 2004/072719 A1; US 2004/072720 A1; EP 1393706 A1; US 2003/203829 A1; US 2003/195133 A1; US 2004/087477 A1; US 2004/0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. Pat. No. RE 32713; U.S. Pat. No. 4,234,627.

In one embodiment of the invention, the shell of the microcapsule comprises an aminoplast resin. A method for forming such shell capsules includes polycondensation. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents (e.g., toluene diisocyanate, divinyl benzene, butane diol diacrylate etc.) may also be used and secondary wall polymers may also be used as appropriate, e.g. anhydrides and their derivatives, particularly polymers and co-polymers of maleic anhydride as disclosed in U.S. Pat. Publ. No. 2004/0087477 A1.

In another embodiment, the shell of the microcapsules comprises urea-formaldehyde; melamine-formaldehyde; or combinations thereof.

In one embodiment, the microcapsule is one that is friable in nature. “Friability” refers to the propensity of the microcapsules to rupture or break open when subjected to direct external pressures or shear forces. For purposes of the present invention, the microcapsules utilized are “friable” if, while attached to fabrics treated therewith, they can be ruptured by the forces encountered when the capsule-containing fabrics are manipulated by being worn or handled (thereby releasing the contents of the capsule).

In one embodiment, the shell capsules typically have a mean diameter in the range 1 micrometer to 100 micrometers, alternatively from 5 micrometers to 80 microns, alternatively from 10 micrometers to 75 micrometers, and alternatively between 15 micrometers to 50 micrometers. The particle size distribution can be narrow, broad or multimodal.

In another embodiment, microcapsules vary in size having a maximum diameter between about 5 microns and about 300 microns, alternatively between about 10 microns and about 200 microns. As the capsule particle size approaches 300 microns, e.g., 250 microns, a reduction in the number of capsules entrained in the fabric may be observed.

In another embodiment, the capsules utilized in the present invention generally have an average shell thickness ranging from about 0.1 micron to 50 microns, alternatively from about 1 micron to about 10 microns.

Cyclodextrin. Another aspect of the invention provides a perfume deliver system comprising a cyclodextrin. As used herein, the term “cyclodextrin” includes any of the known cyclodextrins such as unsubstituted cyclodextrins containing from six to twelve glucose units, especially beta-cyclodextrin, gamma-cyclodextrin, alpha-cyclodextrin, and/or derivatives thereof, and/or mixtures thereof. A more detailed description of the cyclodextrins that may be useful for use in the present invention is described in US 2005/0192204 A1, ¶¶40-43.

Cellular Matrix Microcapsule. Another aspect of the invention provides for a perfume component comprising a perfume cellular matrix microcapsule. Perfume cellular matrix perfume microcapsules, preferable those that are moisture activated and/or water-soluble, are solid particles containing perfume stably held in cells within the particles. Perfume cellular matrix microcapsules are described at US 2005/0192204 A1, ¶44. In one embodiment, the moisture-activated perfume cellular matrix microcapsule comprises a perfume starch microcapsule which uses starch as the cellular matrix material.

Porous Carrier Microcapsule. Another aspect of the invention provides for a perfume delivery system comprising a porous carrier microcapsules. A portion or all of the perfume composition can also be encapsulated by being absorbed onto and/or into a porous carrier, such as zeolites or clays, to form perfume porous carrier microcapsule. Porous Carrier Microcapsules are described at US 2005/0192204 A1, ¶53.

### Fabric Conditioning Active

Another aspect of the invention provides for a multiple use fabric conditioning composition comprising a fabric conditioning active. The term “fabric conditioning active” means any compound that imparts a desired benefit to fabric, that does not include a free perfume ingredient, or a perfume deliver system, or perfume. In one embodiment, the fabric conditioning active is a fabric softening active and/or an antistatic active. It is appreciated that certain actives may have more than one fabric conditioning benefit. Examples of fabric softening actives may include alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof.

Other non-limiting examples of a fabric conditioning active may include those described in US 2003/0195130 A1, ¶¶14-17. In one embodiment, the multiple-use fabric conditioning composition of the present invention comprises from about 1% to about 90%, alternatively from about 5% to about 70%, alternatively from about 10% to about 50%, of a fabric conditioning active.

### Carrier Component

Another aspect of the invention provides a carrier component. The term “carrier component” means a structuring compound that helps contain the fabric conditioning active within the composition, allows the fabric conditioning active to transfer to wet laundry during a drying cycle of an automatic clothing dryer. One such mechanism of action provides the multiple-use fabric conditioning composition, that is solid at ambient temperature, with a melting temperature or a softening temperature that is greater than the operating temperature of the dryer. Exemplary carrier components may include ethylene bisamides, primary alkylamides, alkanolamides, polyamides, alcohols containing at least 12 carbon atoms, alkoxylated alcohols containing alkyl chain of at least 12 carbon atoms, carboxylic acids containing at least 12 carbon atoms, and derivatives thereof. Other examples of carrier components may include those described in US 2005/0192204 A1, ¶¶66-76. In embodiment, the carrier component comprises one or more high melting waxes (e.g., greater than 90° C.).

In one embodiment, the multiple use fabric conditioning composition comprises from about 1% to about 90%, alternatively from about 5% to about 75%, alternatively from about 10% to about 60%, alternatively from about 15% to about 50%, of the carrier component, by weight of the composition.

Processing Agent.

Another aspect of the invention provides for a multiple use fabric conditioning composition comprises a processing agent. Non-limiting example of processing agent is hydrocarbon polymers, such as Vybar 103 polymer, available from Baker Petrolite Polymers Division of Baker Hughes, Sand Springs, Okla. This hydrocarbon polymer may help to eliminate bubbles, mottling and may act as a perfume binder.

Operably Connected or Connectable

The fabric conditioning composition may be operably connected or operably connectable to an inside surface of a tumble dryer, e.g., on a dryer fin (or baffle) of a dryer so that the composition may contact wet laundry during a drying cycle of an automatic clothing dryer. The composition can be operably connected to the inside of the dryer, e.g., by a cradle such as the cradle disclosed by U.S. Patent Pub. No. 2003/0192197.

During the drying cycle, the fabric conditioning composition should release a sufficient amount of the fabric conditioning composition to fabric to provide a desired level of softening and freshening properties and optionally, antistatic properties. In addition, the fabric conditioning composition should not release too much of the fabric conditioning active that would result in spotting of the laundry. It is expected that during the drying cycle, the fabric conditioning composition will release from about 0.01 gram to about 1 gram of the fabric conditioning composition per pound of dry laundry. The amount released per drying cycle can be from about 0.02 to 0.75 gram of the fabric conditioning composition per pound of dry laundry, and can be from about 0.05 to 0.50 gram of fabric conditioning composition per pound of dry laundry. It should be understood that the size of the dryer and the size of the fabric conditioning composition can vary for different types of dryers and drying conditions. For example, there are various sizes of dryers that are commonly used in industrial laundry facilities and in residential or consumer environments.

Optional Ingredients.

The composition of the present invention can contain effective amounts of optional ingredients, such as, soil release agent, chelant, dye transfer inhibitor, dye fixative agent, chlorine scavenging agent, optical brightener, odor control agent, antimicrobial agent, fungicide, wrinkle control agent, anti-oxidant, preservative, plasticizer, insect repellent, moth repellent, processing aid, mold release agent, and mixtures thereof. Preferred soil release polymers, chelants, dye transfer inhibitors, dye fixatives, chlorine scavengers, and anti-oxidants are given in U.S. Pat. No. 6,046,154, issued on Apr. 4, 2000 to Trinh et al. and references cited therein. Preferred odor control agents (such as cyclodextrins, metal salts, and zeolites), wrinkle control agents, antimicrobial agents, fungicides, preservatives, insect repellents, or combinations thereof. In one embodiment, the composition is free or substantially free of one more of the above identified optional ingredients.

Multiple Use

The term “multiple use” means the multiple use fabric conditioning composition of the present invention can be used to deliver a desired amount of fabric conditioning active to laundry during at least two cycles, preferably at least about 10 cycles, more preferably at least about 20 cycles, even more preferably at least about 30 cycles, yet more preferably at least about 40 cycles, and again even more preferably at least about 50 cycles, alternatively not greater than 100 cycles, before the fabric conditioning composition needs to be replaced for drying laundry before it needs to be replaced. It should be understood that the term “laundry” refers to any textile or fabric material that is laundered, especially in a home setting.

The dryers in which the multiple use fabric conditioning composition according to the invention can be used include any type of automatic clothes dryer that uses heat and agitation to remove water from the laundry. An exemplary dryer includes a tumble-type dryer that is heated by electricity or gas, wherein the laundry is provided within a rotating drum that causes the laundry to tumble during the operation of the dryer.

### EXAMPLES

Examples of suitable fabric conditioning compositions include those described at US 2003/0195130, ¶29-51, wherein the perfume used is Perfume A given hereinabove.

The following are more non-limiting examples of the instant composition.

| | Example 1 | Example 2 | Example 3 |
|---|---|---|---|
| Ingredients | Wt. % | Wt. % | Wt. % |
| Acrawax C^{(a)} | 51 | 47.6 | 47 |
| Varosoft DS-110^{(b)} | 45.5 | 45.7 | 45.3 |
| Vybar^{(c)} | 2 | — | — |
| Perfume A (same as above | 2.5 | — | 1 |
| reference for Perfume A) | | | |
| Cyclodextrin/Perfume | — | 6.7 | 6.7 |
| Complex^{(d)} | | | |
| Total | 100 | 100 | 100 |

^{(a)}Ethylene bis-stearamide, available from Lonza.
^{(b)}Varosoft DS-110 comprises about 70% methyl bis-(hydrogenated tallow amidoethyl) 2-hydroxyethyl ammonium methyl sulfate and about 30% alkyl ethoxylate, available from Goldschmidt Chemical Corporation, Janesville, Wisconsin.
^{(c)}Vybar, available from Whacker
^{(d)}Perfume complex of beta-cyclodextrin.

| | Example 4 | Example 5 | Example 6 |
|---|---|---|---|
| Ingredients | Wt. % | Wt. % | Wt. % |
| Acrawax C | 48 | 47 | 40 |
| Varosoft DS-110 | 45 | 47 | 53 |
| Vybar 103 | 2 | — | — |
| Perfume A (same as above | — | 1 | 2 |
| reference for Perfume A) | | | |
| Perfume starch microcapsules | 3 | 3 | — |
| Polyethylene/polypropylene | 2 | 2 | — |
| terephthalate - polyethylene | | | |
| oxide block copolymer | | | |
| Cyclodextrin^{(e)} | — | — | 5 |
| Total | 100 | 100 | 100 |

^{(e)}Uncomplexed beta-cyclodextrin, with particle size of less than about 20 micrometer.

The above formulations may be prepared as follows. The wax carrier, such as Acrawax C, is melted using a beaker and hot plate or feed through a twin screw extruder set at the carrier's melt point (290-320° F. in the case of Acrawax). One skilled in the art will readily appreciate that likely, any type of lab melt system can be used so long as the equipment can be heated to higher then the melting point of the wax carrier. Thereafter, the fabric softening active (e.g., quaternary amine such as Varosoft DS-110 or KRA) is added to the melted was carrier. Results are best obtained with the liquid wax carrier is agitated during fabric softening active addition to allow the active to reach the temperature of melted wax quicker. Results are best obtained, particularly when adding KRA, is to add pre-melted fabric softening active in 10% incremental aliquots to the melted wax and allowing the fabric softening active to entirely melt out before adding the next fabric softening active aliquot. The perfume composition is last ingredient to be added. While keeping the wax carrier and fabric softening active agitated and maintained at a temperature over the melt point of the wax, the perfume is added (pre-melted to a liquid if necessary). A composition carrier (e.g., “product dispenser” and/or “carrier” per U.S. Pat. Publ. No. 2003/0192197 A1) is placed over a mold and secured. The hot melt, of the multiple use fabric conditioning composition, is poured into the mold and is cooled for a minimum of 30 mins. A fan may be used to circulate air to expedite the cooling of the bar. After the external temperature of the bar is less than the melt point of the fabric softening active by more than 20° F., the bar can be ejected from the mold (along with the product carrier).

In Examples 4 and 5, the poly(ethylene/propylene) terephthalate-polyethylene oxide terephthalate block copolymer is added to the melt mixture of wax carrier and fabric softening active with mixing. The starch perfume microcapsules may be added to the melt mixture thereafter.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

Except as otherwise noted, the articles “a,” “an,” and “the” mean “one or more.”

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multiple use fabric conditioning composition comprising:
(a) a fabric conditioning active;
(b) a carrier component;
(c) a free perfume composition comprises at least one perfume ingredient comprising a ClogP equal to or higher than about 3.0; and
(d) wherein the composition is operably connectable to an inside surface of an automatic clothing dryer.

2. The composition of claim 1, wherein at least about 50%, by the total weight of free perfume composition, of free perfume ingredients comprise a ClogP equal to or higher than about 3

3. The composition of claim 2, wherein at least about 70%, by the total weight of free perfume composition, of free perfume ingredients comprise a ClogP equal to or higher than about 3; wherein said free perfume ingredients having a ClogP equal to or higher than about 3 comprise from about 0.1% to about 10% by weight of the fabric conditioning composition.

4. The composition of claim 1, wherein at least 50%, by the total weight of the free perfume composition, of free perfume ingredients comprise a ClogP equal to or higher than about 3.5.

5. The composition of claim 4, wherein at least about 70%, by the total weight of free perfume composition, of free perfume ingredients comprise a ClogP equal to or higher than about 3.5; wherein said free perfume ingredients having a ClogP equal to or higher than about 3.5 comprise from about 0.1% to about 10% by weight of the fabric conditioning composition.

6. The composition of claim 5, wherein the free perfume ingredients having a ClogP equal to or higher than about 3 are further characterized in that at least about 25%, by total weight of said free perfume composition, comprise a boiling point equal to or higher than about 240° C.

7. The composition of claim 5, wherein the free perfume ingredients having a ClogP equal to or higher than about 3 are further characterized in that at least about 25%, by total weight of said free perfume ingredient, comprise a boiling point equal or higher than about 250° C.

8. The composition of claim 5, wherein the free perfume ingredients having a ClogP equal to or higher than about 3.5 are further characterized in that at least about 25%, by total weight of said free perfume composition, comprise a boiling point equal to or higher than about 240° C.

9. The composition of claim 5, wherein the free perfume ingredients having a ClogP equal to or higher than about 3.5 are further characterized in that at least about 25%, by total weight of said free perfume ingredient, comprise a boiling point equal or higher than about 250° C.

10. The composition of claim 8, wherein the multiple use comprises at least forty dryer cycles.

11. The method of softening fabric comprising the step of operably affixing the composition of claim 1 to an inside surface of an automatic clothing dryer.
